(19) United States
(12) Patent Application Publication
(10) Pub. No.: US 2013/0234818 A1
(43) Pub. Date: Sep. 12, 2013

(54) MAGNETIC DRIVE ASSEMBLY

(71) Applicant: Orlando M. Garcia, Buenos Aires (AR)

(72) Inventor: Orlando M. Garcia, Buenos Aires (AR)

(73) Assignees: Orlando Moises Garcia, Buenos Aires (AR); Antonio Daniel Papasodaro, La Plata, Buenos Aires (AR)

(21) Appl. No.: 13/809,873

(22) PCT Filed: Jul. 13, 2011
(86) PCT No.: PCT/US11/43819

§ 371 Date: May 21, 2013

(30) Foreign Application Priority Data
Jul. 14, 2010 (AR) 20100102543

(51) Int. Cl. H01F 7/02

(52) U.S. Cl. CPC H01F 7/0242
USPC 335/306

(57) ABSTRACT

A magnetic drive assembly comprising at least one fixed magnetic core and at least one mobile magnetic core, whereby each magnetic core, which may be fixed or mobile, contains a plate formed by polygonal magnetic units, nested among themselves according to the corresponding concave and convex sides of each unit, in such a way that together they form circularly expanding magnetic field forces that interact amongst themselves to cause rotation of the mobile magnetic core.

### RELATED APPLICATIONS

This application claims the benefit of Argentine Patent Application No. 20100102543 entitled “Magnetic Drive Assembly” filed on Jul. 14, 2010 the contents of which are incorporated herein by reference in its entirety.

### BACKGROUND OF THE INVENTION

1. Field of the Invention

The present invention is related to the field of devices, equipment and assemblies that use magnetic fields to generate movement and, more particularly it refers to a magnetic drive assembly that is based on an activated universal structure which, using attraction and repulsion, naturally generated by magnets, produces a rotary motion whose power and speed can be controlled in order to be used for power generation.

2. Description of the Prior Art

Today, power is generated by using different natural resources that avoid the consumption of non-renewable and polluting fuels. Examples of these resources are wind and solar power which, although they do not pollute, have extremely high manufacturing and production costs.

As an answer to these problems of pollution and high costs, investigations on new drive equipment based on the attraction and repulsion power of magnets are being conducted. Typically, all permanent magnet motors consist of a rotor which, in its periphery, has a permanent magnet assembly facing the inner periphery of a stator, the latter also including a plurality of permanent magnets, which positions are combined in such a way with those in the rotor that, once an initial impulse is provided, the rotor starts turning as a result of the magnetic field created by each of the permanent magnets in the rotor and stator facing each other. Even though several projects and videos exist showing these motors operating during a considerable amount of time, the arrangement of the magnets along the peripheries and their precise positioning in order to achieve interaction is still a highly complex technical problem. Such motors, with a peripheral design, have not worked satisfactory, i.e. it has not been possible to achieve the level of speed, uniformity over time and force that are needed to obtain useful motion or power.

After several years of research, the inventor left behind the common pattern used by several permanent magnet drive machines and followed a very different road from radially opposed permanent magnets as seen in the prior art. He studied the behavior of the forces in a magnetic field created by magnets of different shapes, as well as the arrangement of rotors and stators integrally formed by magnetic units.

Proof of the above can be found in the Argentine Patent Application Act No. 9 060102290, relating to a motion generator that uses attraction and repulsion magnetic forces of permanent magnets, whereby such magnets are crescent-shaped and are aligned along a rotation axis. Such crescent-shaped units generate curved magnetic force lines which improve the rotation of a rotor assembly with respect to a stator assembly. The rotor and stator asssemblies are composed of said crescent-shaped magnetic units, which are respectively aligned and spaced apart in an alternate arrangement. The combination of curved force lines in the forward and backwards rotation directions of the rotor, considerably improve the rotation of the rotor with respect to the stator.

Although the assembly of the above-mentioned patent application was an improvement as compared to the radially and peripherically-arranged drive machines, there was still room for further improvement. Therefore, the inventor developed a new magnetic rotation generator which he submitted under Patent Application No. P 070103114, also consisting of crescent-shaped magnetic units intended to curve the magnetic force lines and cause the rotation of the rotor, but this time employing crescent-shaped units symmetrically superimposed with respect to the central crescent in each fixed or rotational core, i.e. in each stator or rotor. This configuration of symmetric superposition of the magnetic units in the form of a crescent improved the efficiency of the generator even more, compared to patent application of the year 2006; nevertheless the inventor continued his work on the design and the restructuring of a new magnetic drive assembly that would provide better operational uniformity over time, speed and working force, which would make it very useful in any industrial, commercial, home, vehicle activities and many other applications.

### BRIEF DESCRIPTION OF THE INVENTION

It is therefore an object of the present invention to provide a new technology based on the magnetic mechanics of attraction and repulsion of magnetic forces set up in an activated universal structure that is capable of generating exploitable movement by means of at least a rotor and stator, both discoidal, which are axially opposed to rotate with respect to each other.

It is yet another objective of the current invention to provide a magnetic drive assembly that consists of at least one fixed magnetic core and at least one mobile magnetic core, whereby each magnetic core, be it fixed or mobile, contains a plate formed by polygonal magnetic units nested among themselves according to the corresponding concave and convex sides of each unit, in such a way that together they compose circularly extended magnetic field forces that interact amongst themselves to provoke the rotation of the mobile magnetic core.

It is yet another goal of the current invention to provide a magnetic drive assembly that consists of an activated universal structure composed by at least a fixed magnetic core and at least a mobile magnetic core between which magnetic fields of attraction and repulsion are established that cause said mobile magnetic core to rotate with respect to said fixed magnetic core, and where each of said fixed and mobile magnetic cores a disk-like shaped body and is formed by a plurality of radial blocks, whereby each of said blocks minus one contains a magnetic unit with a concave polygon shape, whereby a concave edge of each magnetic unit is placed in contact with a convex edge of an adjacent magnetic unit and wherein said back-to-back edges of each adjacent magnetic unit have mutually repulsing polarities.

It is yet another object of the present invention to provide a magnetic drive assembly comprising a universal activated structure including at least one fixed magnetic core and at least one mobile magnetic core between which attraction and repulsion magnetic field forces are established, causing said mobile magnetic core to rotate with respect to said fixed magnetic core, wherein each of said fixed and mobile magnetic cores comprises at least one disk-shaped body with multiple radial blocks, wherein said radial blocks comprise an empty block and at least one block formed by a crescent-shaped magnetic unit, each of said crescent-shaped magnetic units having opposing sides with different magnetic polarities, wherein each magnetic core is formed by multiple magnetic units axially adjacent to each other by means of their opposing polarity sides, so to keep the multiple magnetic units fixed to each other by the attraction force of their opposing magnetic polarity, wherein each fixed magnetic core faces at least one mobile magnetic core, so that the sides of the fixed and mobile magnetic units facing each other are of the same polarity, thus generating a mutually repulsive force between the cores.

### BRIEF DESCRIPTION OF THE DRAWINGS

For greater clarity and understanding, the object of the current invention, has been illustrated in several figures, where the invention is represented in one of its preferred embodiments, all by way of illustration, wherein:

FIG. 1 shows a schematic perspective view of a magnetic core consisting of magnetic units in agreement with one of the embodiments of the invention;

FIG. 2 shows a perspective view of a magnetic unit of the invention;

FIG. 3 shows a perspective view of an alternative embodiment of the magnetic unit of the invention;

FIG. 4 shows an elevated side-view of a drive assembly consisting of a fixed core and two mobile cores in agreement with another embodiment of the invention, and

FIG. 5 shows an elevated frontal view of the drive assembly shown in FIG. 4.

FIG. 6 is a perspective view of a drive assembly with crescent-shaped magnetic units arranged around a vertical axis, comprising a fixed central core and two mobile cores, according to another embodiment of the present invention, where only the magnetic units have been illustrated schematically, excluding any other structural portions of the assembly,

FIG. 7 is a perspective view of a mobile magnetic core comprising three disk-shaped bodies, where a magnetic unit housed within a support plate is shown in exploded view,

FIG. 8 is a perspective view of a fixed magnetic core comprising multiple disk-shaped bodies, where a magnetic unit housed within an upper end support plate is shown, and,

FIG. 9 is an elevational and cross-sectional view of a drive assembly according to the embodiment of FIG. 6.

### DETAILED DESCRIPTION OF THE INVENTION

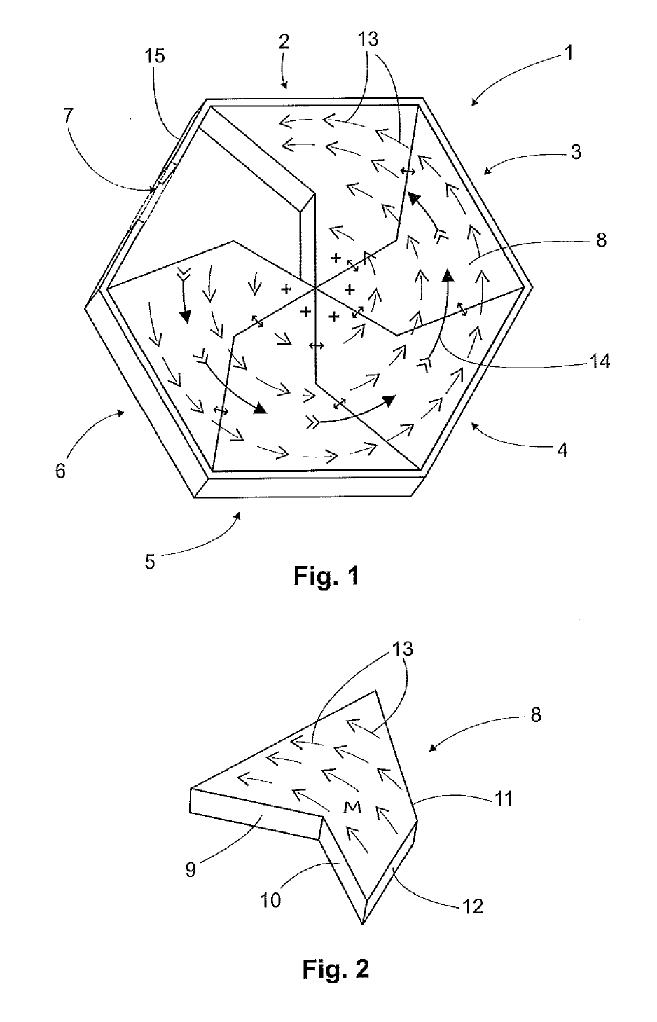

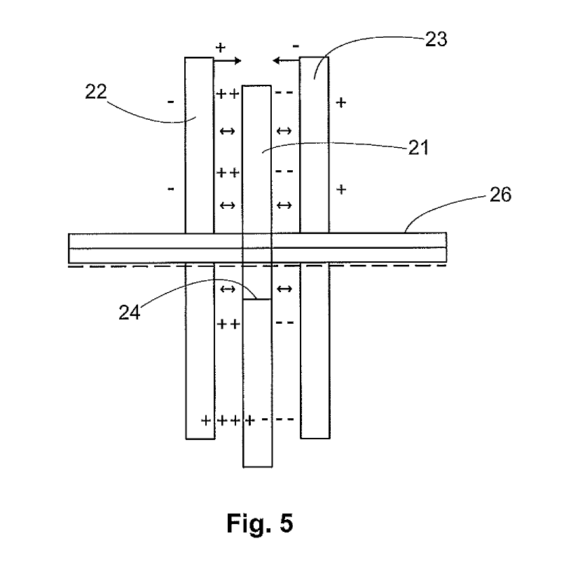

Referring to the figures in detail, we see that the invention consists of a magnetic drive assembly that is based on an activated universal structure consisting of at least a fixed magnetic core and at least a mobile magnetic core, as shown in FIG. 1, and adapted to complement each other as is shown, by way of example, in FIGS. 4 and 5, in such a way that magnetic fields of attraction and repulsion are created, causing said mobile magnetic core to rotate with respect to said fixed magnetic core. As shown in FIG. 1, both the fixed core or stator and the mobile core or rotor can consist of a quasi-discoidal body, i.e. a polygonal body with as many sides as needed, getting closer to the discoidal body as the amount of sides increases.

By way of example, we will take the magnetic core indicated with numeral 1 in FIG. 1, as the fixed core but it should be noted once again that its conformation is also valid for the mobile core unless otherwise specified. The magnetic core 1 is made up of a body consisting of a plurality of radial blocks 2 to 7, where all blocks 2 to 6, not block 7, comprise a concave polygonal magnetic unit 8. Just one of the magnetic units has been identified with the numeral 8, as all of them are identical units, therefore this numeral 8 is valid for all of them and is also used in FIG. 2.

Each magnetic unit 8 contains a magnetic piece, i.e. a concave polygonal permanent magnet and preferably a pentagonal or hexagonal concave polygon. However other concave polygonal shapes are also provided. According to the invention, the magnetic units 8 are nested among themselves in such a way that their concave edges are placed in contact with the convex edges of an adjacent unit, causing increased drag force of the magnetic forces obtained by the configuration. More particularly, a concave edge of each magnetic unit 8 will be defined by the edges or sides 9 or 10 of the polygon, which will be placed in contact with the convex edge of an adjacent magnetic unit, formed by the edges 11 and 12 or convex sides of the polygon.

According to the preferred embodiment of the invention, the adjacent edges of each magnetic unit will have mutually repelling polarities. In other words, the edges 9 and 10 of a unit 8 will have the same polarity, be it positive or negative, as the contacting edges 11 and 12 of the adjacent unit 8. The aim of the invention is to produce movement and average force of repulsion and attraction that the magnets produce naturally or artificially, by way of a configuration of the magnets that allows for the magnetic force lines to be artificially curved as indicated by arrows 13, generating a circular force vector 14 as a result. Consequently, circular, elliptical or other forces and movement are created, and it becomes possible to leverage this movement and force for different activities.

The magnetic units should be lined up in a quasi-circular pattern, but it is extremely important that the magnetic units are mutually connected with the same polarity. As has been explained before, when we try to connect one magnetic unit to another, i.e. edges 9 and 10 against edges 11 and 12, these will exert a strong repulsion, making it necessary to press them together until the separating space is reduced to a minimum, as a result of which a fixed core is obtained with a positive and a negative side and at the connections of the magnets a highly compressed bipolar magnetic energy line is produced, which allows for the directioning of the mobile core(s). In FIGS. 1 and 2 the positive side has been indicated with a “+” sign and the opposite side with a “−”. The repulsion force between the peripheral edges of the magnetic units 8 are indicated with double pointed arrows that cross the connection line between the edges. The method by which the units 8 are held against each other under said repulsion force can be any type of retention capable of keeping the units 8 forced together. For example, these retention means can consist of a peripheral ring 15 that is partially illustrated in section in correspondence with block 7 but is continuous all around body or core 1.

As will be explained in relation with FIGS. 4 and 5, the magnetic assembly or device works using two cores, one fixed core and a mobile core, each of them made up by magnetic units 8, specifically designed to increase the curvature of the magnetic force lines and the compression. The bigger the amount of units that are used, the bigger the displacement and the force within the circumference will be, as well as the degree of transfer. The magnets are aligned in order to form a quasi-circumference, without reaching 360°, leaving a block 7 with free space equivalent to the size of a magnetic unit 8. Consequently, the circle is closed with block 7, missing a magnetic unit.

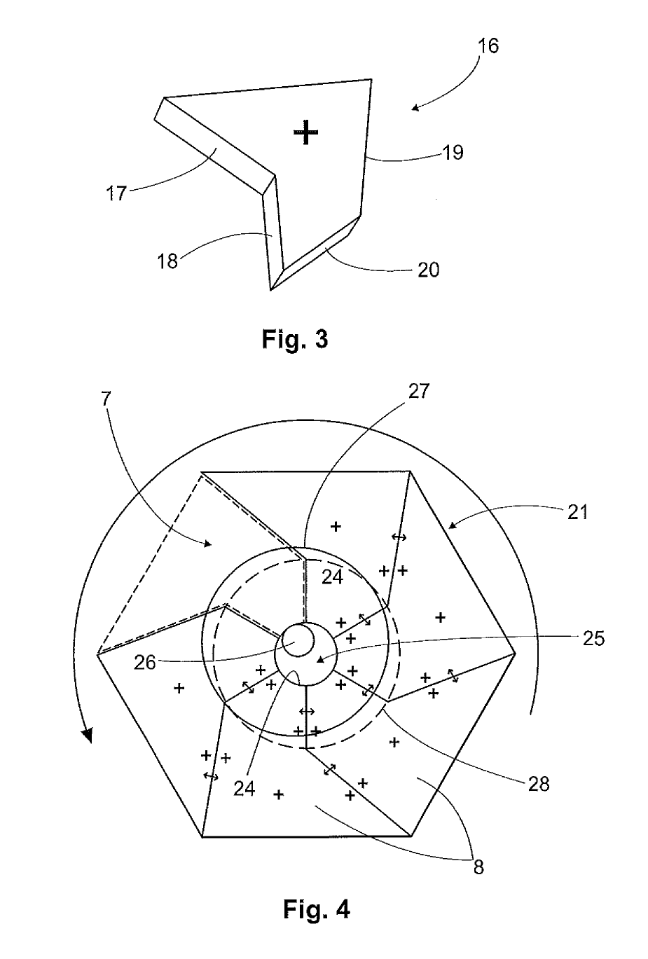

In FIG. 3, an alternative embodiment is illustrated of the magnetic unit which has been indicated with numeral 16, which has edges 17 and 18 on a concave side of the polygon and edges 19 and 20 on a convex side of the polygon. As mentioned before, the magnetic units 8 and 16 can adopt several concave polygonal figures, preferably but not limited to hexagonal and pentagonal shapes.

As illustrated in FIGS. 4 and 5, the magnetic cores consist of a composed drive assembly, in agreement with one of the embodiments of the invention, a fixed core 21 and two mobile cores 22 and 23. For the sake of clarity, in FIG. 4 only the fixed core 21 has been illustrated. The cores or rotors 22 and 23 can be independent, i.e. mounted on their own rotation axis and separated or can adopt the configuration illustrated in FIGS. 4 and 5. For this purpose, a central vertex of each magnetic unit of said fixed magnetic core shows a circular section 24 so the fixed magnetic core shows a central through orifice 25. Consequently, the mobile magnetic cores 22 and 23 will be joined by means of a central rotation shaft 26 which passes through said orifice 25 of the fixed magnetic core. The axis 26 of the mobile magnetic core has an external diameter that is inferior to the internal diameter of said orifice 25 of the fixed magnetic core 21 in such a way that the axis 26 does not only rotate within the orifice 25 but also moves inside of it, hereby defining an orbit 27 indicated as a full-line circle in FIG. 4. For reasons of comparability, an orbit 28, which corresponds to the center of the fixed core 21, is indicated with a dashed line

The pattern of providing a mobile core on each side of the fixed core can be repeated as many times as needed to obtain a multiplication of the resulting forces. Note that between a mobile core and a fixed core the polarity of the cores is identical and consequently a repulsion camp is established which, as a result of the curve forces on these opposed faces, and the free block 7 generate magnetic forces that cause the mobile core to rotate with respect to the fixed core. Furthermore, two or more magnets of the fixed core can be superposed and two or more magnets of the mobile core can be joined symmetrically. The magnetic units can also be joined symmetrically using a central unit to compress the magnetic force lines into a conical spiral shape. The units can also be placed at a distance and at different convenient angles depending on the degrees of rotation that are needed.

The magnets can have any thickness and size and it is possible to potentiate the units by increasing their volume and/or size and/or thickness and/or using several cores in series until the required amount of power is reached. The position of axis 26 and fixed core 21 is important as it should be positioned on the lower side where the fixed core 21 does not have a magnetic unit. The mobile core rotates freely and takes position above the center of the fixed core, which imports, as has been explained, a differentiated orbit 27 into the mobile core, compared to the circular orbit 28 of the fixed core, which is fundamental for the correct functioning of the magnetic mechanics. Said mobile magnetic cores can be at the same or a different height and also present their angularly offset magnetic units. Obviously, the drive assembly can be integrated into an electrical motor and alternator that produces electricity.

As can be seen in the previous description, the current invention concerns a mechanical device that allows for the generation of force, regulated speed, without the need for gears, energy or external force. Said device uses functional magnetic mechanics which we prefer to call activated universal structure, by means of magnetic multipolar interactions and of a structure created to guide the magnetic flow, as can be seen in FIGS. 1, 2 and 4, which allows for the transfer of the force and mass of 0° to almost 360°, without the need for external force. Only the force is created in the structure or configuration is used, making it possible to control and regulate this magnetic phenomenon, hereby obtaining any relation force/speed in agreement with the specific needs and scale that are required. This novel configuration has been created based on the magnetic mechanics and allows for the use of this medium to perform multiple mechanical tasks, among which the production of electrical energy. The magnetic mechanics make it possible to use little energy for its activation and immediately offer a better relation of generated energy/force that is used, even more than double, and the overload of energy/force can be used for another activity such as the production of electrical energy. The difference between the energy/force at the inlet and the energy/force at the outlet is very wide and can be adapted to any specific need. Another important characteristic of the magnetic mechanics is that the initial force needed to activate it causes low wear, i.e. that while active, the external force works at minimum power, the kinetic force, centrifugation and gravity are fundamental elements of the magnetic mechanics.

In a practical example, an electrical motor has been used with an initial drag force of 300 grams with 500 revolutions per minute, with the creation of magnetic mechanics with initial drag force of 1 kilogram at the activation of the described configuration. The magnetic mechanics directed to a specific point allows for the electrical motor to start working and after a couple of revolutions the electrical motor was working almost without effort and the magnetic mechanics facilitated the creation of one kilo of mass at 500 revolutions per minute. In other words, greater energy and force has been generated than there was present at the inlet, which can be used for any other activity. This configuration, taken as an example, is completely scalable for bigger differences.

According to another aspect of the present invention, the disk-like shaped body and the magnetic units with a concave polygonal concave of the embodiments illustrated in FIGS. 1 to 5, have been modified into a disk-shaped body and crescent-shaped units, such as will be described hereinbelow.

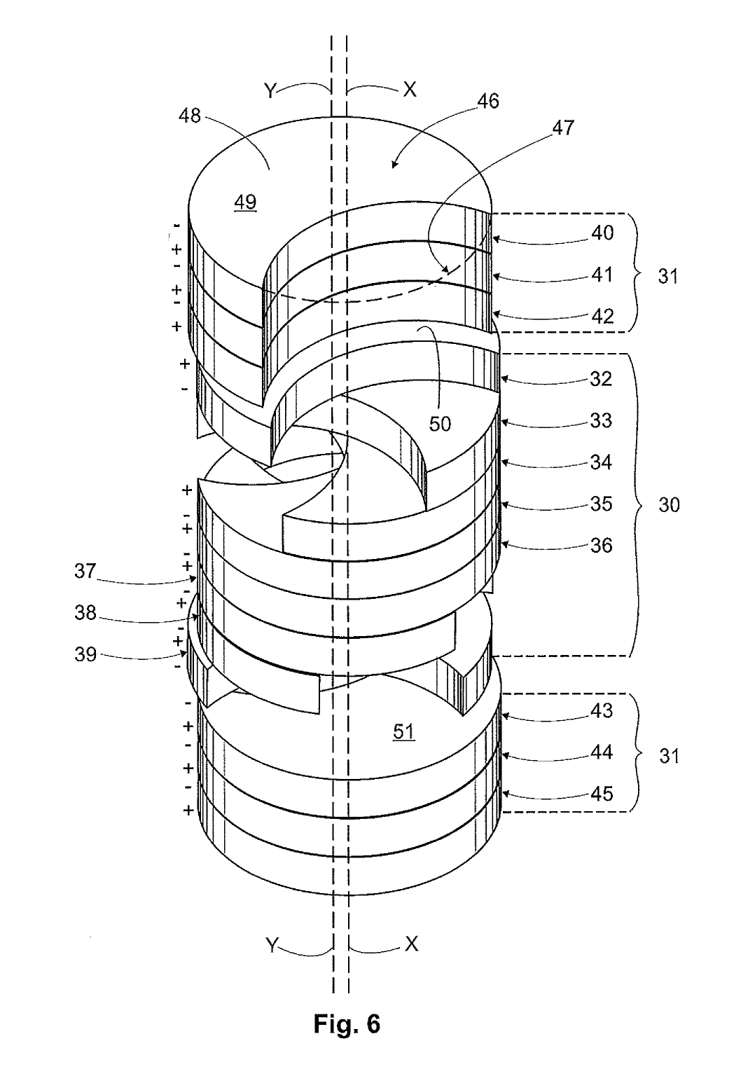

FIG. 6 is a schematic perspective view of a drive assembly marked with general numeral 29, comprising one fixed central core 30 and two mobile cores 31, 31A. Only the magnetic units have been schematically illustrated in this Figure, so that the arrangement of the units relative to each other can be clearly seen; therefore other structural portions of the assembly are not shown.

As seen in FIG. 6, each of said fixed magnetic core 30 and mobile magnetic cores 31, 31A, comprise at least one disk-shaped body. Thus, the fixed magnetic core 30 comprises 7 magnetic bodies 32-39, while the mobile magnetic cores 31 and 31A comprise the bodies 40-42 and 43-45, respectively. In the description of the disk-shaped bodies 32-45, reference will be made only to disk-shaped body 40, since its illustration will allow for a better understanding of its parts. However it should be noted that the description of body 40 is also valid for all the other magnetic bodies. Each magnetic body comprises multiple radial blocks, in this particular case one block 46 and one block 47 defined by the dotted line. Block 47 is an empty block space or a block made of a non-magnetic material, while the other block 46 comprises a crescent-shaped magnetic unit 48. Each crescent-shaped magnetic unit 48 has two opposing sides, one of which is shown as upper side 49 while the other cannot be seen in FIG. 6. Said opposing sides have different magnetic polarities, as shown with the symbols (+) and (−) next to each magnetic unit. The magnetic units 48 of bodies 40-42 within magnetic core 31 are fixed to each other by their sides with opposing polarities, so that the magnetic attraction force keeps them together. The same applies to magnetic units in bodies 43-45 within core 31A and magnetic units in bodies 32-39 within magnetic core 30.

According to the present invention, each fixed magnetic core 30 faces at least one mobile magnetic core, in this case cores 31, 31A, so that the sides of fixed and mobile magnetic cores facing each other are of the same polarity, thus generating a mutually repulsive force between the cores. In other words, the lower side of magnetic unit in body 42 has the same polarity as the upper side, with numeral 50, of the magnetic unit of body 32, thereby creating a repulsion force between magnetic cores 30 and 31. The same applies to magnetic cores 30 and 31, since the lower side of magnetic unit of body 39 has the same polarity as the upper side, marked with numeral 51, of magnetic unit of body 43, thereby generating a repulsion force between magnetic cores 30 and 31A.

Also according to the teachings of the present invention, the fixed magnetic core has its magnetic burring bodies aligned along a first longitudinal axis X-X, while the one or more mobile magnetic cores have their magnetic bodies aligned along a second longitudinal axis Y-Y, so that such first axis X-X and second axis Y-Y are offset and parallel to each other.

As seen in FIG. 6, the magnetic units of disk-shaped bodies 40-42 of core 31 match and are axially linked to each other. Similarly, the magnetic units of disk-shaped bodies 43-45 of core 31A match and are axially linked to each other. However, said mobile magnetic cores 31, 31A are axially arranged so that their respective crescent-shaped magnetic units are offset at a certain angle and, preferably, they are offset so as to be diametrically opposed to each other. This must be interpreted as meaning that magnetic units 48 of bodies 40-42 of core 31 are arranged in diametrically opposed manner to magnetic units of bodies 43-45 of core 45, but preferably in such a way as not being exactly diametrically opposed. Also preferably, cores 31, 31A are mobile cores, but they can be fixed as well.

Magnetic core 30, which can also be either fixed or mobile, depending whether cores 31, 31A are respectively mobile or fixed, comprises the magnetic units that form magnetic bodies 32-39, axially fixed to each other and with an angular offset with respect to each other. The angular offset between each magnetic unit is given by “n”, the number of magnetic bodies forming the magnetic core. For example, if the core is made of 7 bodies, as illustrated, the angular offset between two magnetic units is of 450° divided by “n”. Preferably 6 bodies per core will be used, therefore the angular offset between two magnetic units will be equal to 360° divided by “n”, that is 60°.

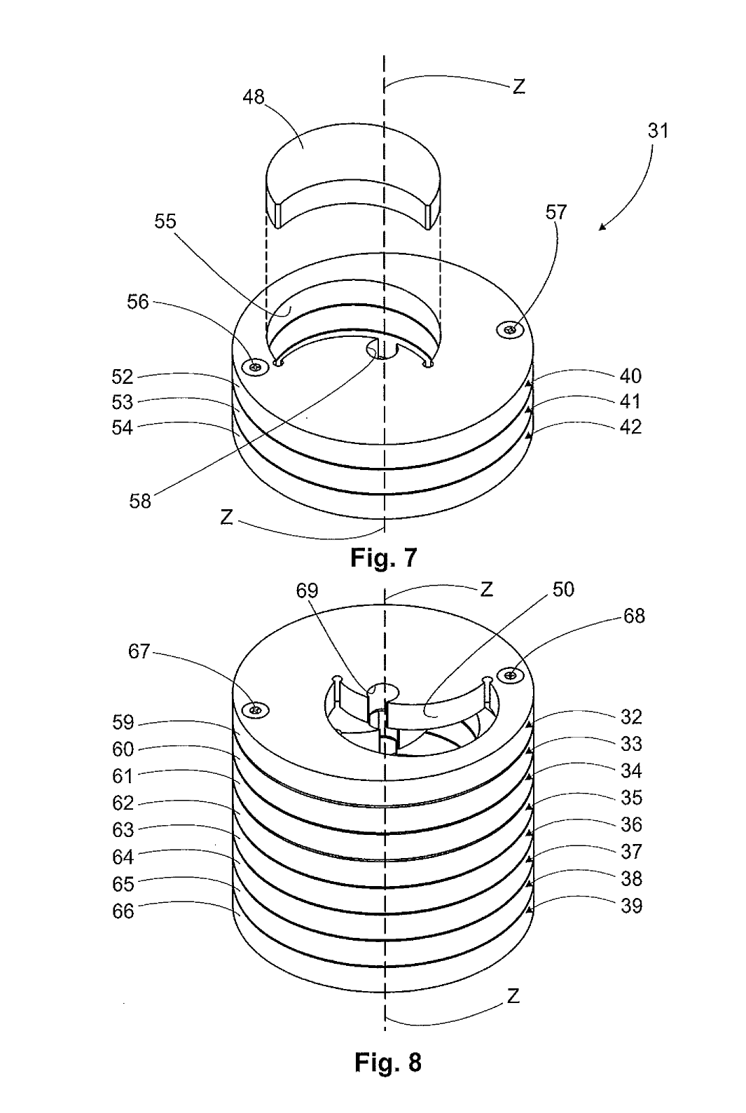

FIG. 7 is a perspective view of a mobile magnetic core, for example core 31, formed by three bodies 40-42. Each disk-shaped body 40-42 is formed by a disk-shaped support plate 52-54, respectively, wherein each support plate has a through opening, of which only opening 55 of plate 52 is shown, magnetic unit 48 being housed whithin said opening, which is shown in exploded view. Plates 52-54 are both arranged in alignment along the same geometric axis, but openings 55 will be cut in each plate so as to be in matching relationship as shown in FIG. 6. The plates can be fixed to each other by means of through bolts 56, 57. Additionally, the plates will have a central through opening 58, such that the openings will be aligned along a central axis Z-Z around which core 31 and the assembly rotate. The embodiment shown in FIG. 7 for core 31 is also valid for core 31A, except for the fact that openings 55 are cut in the plates of core 31A so that the units of bodies 43-45 will be oriented as shown in FIG. 6.

FIG. 8 is a perspective view of a fixed magnetic core, for example core 30, which is formed by eight bodies 32-39, however they could be more than eight, or seven or less as well. Each disk-shaped body 32-39 is formed by a disk-shaped support plate 59-66, respectively, wherein each support plate has a through opening, of which only opening 66 of plate 59 is shown, within which a magnetic unit is housed. The figure shows the upper side 50 of the magnetic unit, which is also shown in FIG. 6. Plates 59-66 are aligned along the same geometrical axis Z-Z, but openings 66 will be cut in each plate so as to keep the positions of the magnetic units in bodies 32-39 with an offset with respect to each other as shown in FIG. 6. The plates can be fastened to each other by means of through bolts 67-68. The plates will also have a central through opening 69, so that the openings will be aligned along a central axis around which core 30 and the assembly rotate.

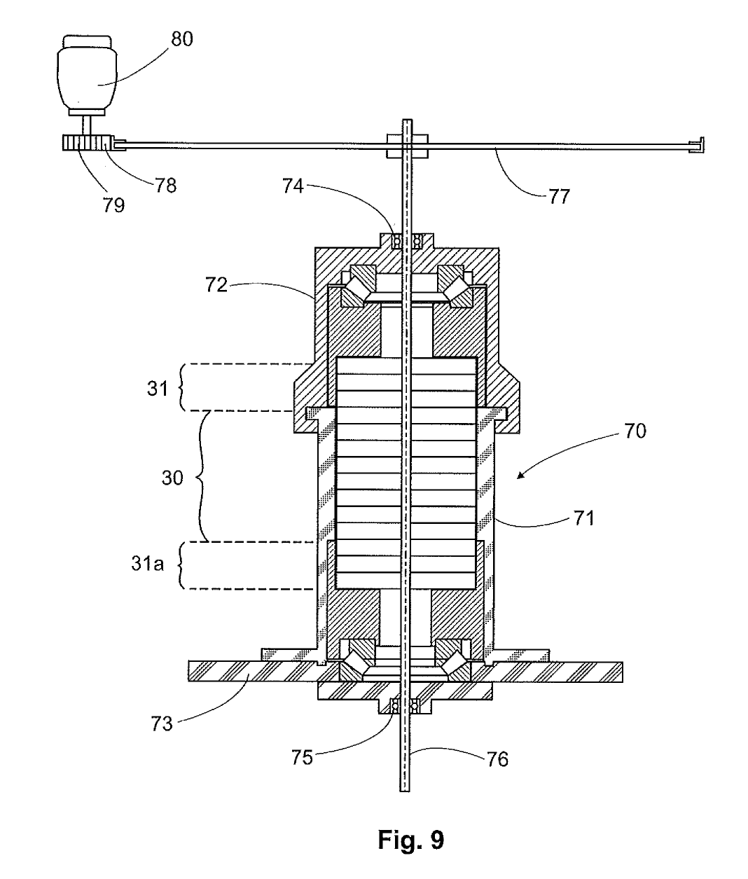

As shown in FIG. 9, disk-shaped plates 52-54, 59-66 forming the disk-shaped bodies 32-39, 40-42 and 43-45 are housed in alignment along said central rotating axis Z-Z, within a fixed housing 70, made of non-magnetic material, like, for example, aluminum or others, said housing comprising a cylindrical body 71 which is respectively closed on either end by a hood-shaped upper cap 72, and lower cap 73, including bearings 74, 75, which support a central rotating axle or arbor 76, which can be linked on one of its ends to a driven machine that allows the use of power and, on the opposite end, to a flywheel 77 which in turn can be connected to a motor starter 80 by means of a coupling mechanism with a pinion 79 and a crown wheel 78.

It must be noted that the concepts described for the embodiments of FIGS. 1 to 5 are also applicable to the embodiments of FIGS. 6 to 9, as much as possible. The fixed and mobile cores can be interleaved in any desired number and can also be repeated either in a single axial assembly or in several parallel assemblies. Similarly, the axial arrangement of the magnetic cores can be referred to a horizontal, vertical or slanted geometrical axis, and the core diameters can be equal or different.

1. A magnetic drive assembly that comprises an activated universal structure composed by at least one fixed magnetic core and at least one mobile magnetic core among which magnetic force fields of attraction and repulsion are established that cause said mobile magnetic core to rotate with respect to said fixed magnetic core, characterized in that:
each of said fixed and mobile magnetic cores consists of a disk-like shaped body that is formed by a plurality of radial blocks, each of these blocks minus one containing a concave polygonal magnetic unit, a concave edge of each magnetic unit being placed in contact with a convex edge of an adjacent magnetic unit and said contacting edges of each adjacent magnetic unit having mutually repelling polarities.

2. The assembly of claim 1, characterized in that the magnetic units are kept together by force using retention means.

3. The assembly of claim 2, characterized in that said retention means consists of a peripheral ring.

4. The assembly of claim 2, characterized in that said magnetic unit is a pentagonal concave polygonal magnetic plate.

5. The assembly of claim 2, characterized in that said magnetic unit is a hexagonal concave polygonal magnetic plate.

6. The assembly of claim 1, characterized in that a central vertex of each magnetic unit of said fixed magnetic core has a circular section whereby the fixed magnetic core has a central through orifice.

7. The assembly of claim 1, characterized in that said mobile magnetic core has a central rotation shaft.

8. The assembly of claim 6, characterized in that said central rotation shaft of the mobile magnetic core passes through said orifice of the fixed magnetic core.

9. The assembly of claim 8, characterized in that said axis of the mobile magnetic core has an external diameter smaller than an internal diameter of said orifice of the fixed magnetic core.

10. The assembly of claim 7, characterized in that it contains a fixed magnetic core and a mobile magnetic core on each side of said mobile magnetic core, both mobile magnetic cores being attached to said central rotation shaft.

11. The assembly of claim 7, characterized in that it contains a plurality of fixed magnetic cores and a plurality of mobile magnetic cores, the mobile magnetic cores being attached to said central rotation shaft.

12. The assembly of claim 11, characterized in that said mobile magnetic cores have their magnetic units being angularly offset relative each other.

13. A magnetic drive assembly comprising a universal activated structure comprising at least one fixed magnetic core and at least one mobile magnetic core between which attraction and repulsion magnetic field forces are established driving said mobile magnetic core to rotate with respect to said fixed magnetic core, said assembly characterized in that:
Each of said fixed and mobile magnetic cores comprises at least one disk-shaped body and multiple radial blocks, wherein said radial blocks comprise one empty block space and at least one block formed by a crescent-shaped magnetic unit, said crescent-shaped magnetic unit comprising opposing sides with different magnetic polarities, each of said magnetic core being formed by multiple magnetic units axially adjacent to each other by means of their sides of opposite polarity, so to keep them fastened by the attraction force of their magnetic polarity, each fixed magnetic core facing at least one mobile magnetic core so that the sides of the fixed and mobile magnetic cores facing each other are of the same polarity, thus generating a mutually repulsion force between the cores.

14. An assembly according to claim 13, characterized in that at least one of said magnetic cores is formed by multiple disk-shaped bodies where the at least one crescent-shaped magnetic unit of a disk-shaped body and the at least one crescent-shaped magnetic unit of an adjacent disk-shaped body are axially matching and linked to each other.

15. An assembly according to claim 13, characterized in that at least one of said magnetic cores is formed by multiple disk-shaped bodies wherein at least one crescent-shaped magnetic unit of a disk-shaped body and the at least one crescent-shaped magnetic unit of an adjacent disk-shaped body are axially linked and with an angular offset among them.

16. An assembly according to claim 14, characterized in that said magnetic core with crescent-shaped magnetic units axially matching and linked to each other, is a mobile magnetic core.

17. An assembly according to claim 15, characterized in that said magnetic core with crescent-shaped magnetic units axially matching and linked to each other, is a fixed magnetic core.

18. An assembly according to claim 16, characterized in that it comprises one fixed magnetic core and one mobile magnetic core on either side of said fixed magnetic core, said mobile magnetic cores being arranged axially so that their respective crescent-shaped magnetic units have an angular offset with respect to each other.

19. An assembly according to claim 18, characterized in that said magnetic units of said mobile crescent-shaped magnetic cores have a diametrically opposed angular offset with respect to each other.

20. An assembly according to claim 15, characterized in that said magnetic core with its crescent-shaped magnetic units axially linked and with an angular offset with respect to each other, has a number “n” of disk-shaped bodies and the angular offset between two magnetic units is equal to an angle of 450° divided by “n”.

21. An assembly according to claim 15, characterized in that said magnetic core with its crescent-shaped magnetic units axially linked and with an angular offset with respect to each other, has a number “n” of disk-shaped bodies and the angular offset between two magnetic units is equal to an angle of 360° divided by “n”.

22. An assembly according to claim 13, characterized in that said at least one fixed magnetic core is aligned with a first longitudinal axis and said at least one mobile magnetic core is aligned with a second longitudinal axis, and said first and second longitudinal axis are offset and parallel to each other.

23. An assembly according to claim 22, characterized in that each disk-shaped body is formed by a disk-shaped plate with one through opening within which said at least one crescent-shaped magnetic unit is housed.

24. An assembly according to claim 23, characterized in that each disk-shaped plate has a central opening to allow passage of a central rotating axis of the assembly therethrough.

25. An assembly according to claim 24, characterized in that all the disk-shaped plates forming the disk-shaped bodies are enclosed in an axially aligned fashion along said central rotating axis, within a fixed housing.

26. An assembly according to claim 25, characterized in that said fixed housing comprises a cylindrical body that is closed on either ends by respective caps including bearings to support said central rotating axis, being said central rotating axis connected to a motor starter.

27. The assembly of claim 7, characterized in that said central rotation shaft of the mobile magnetic core passes through said orifice of the fixed magnetic core.
